(19) United States
(12) Patent Application Publication
(10) Pub. No.: US 2003/0085887 A1
(43) Pub. Date: May 8, 2003

(54) Method and system for identifying objects using a shape-fitting algorithm

(75) Inventors: W. Ben Hunt, Weston, CT (US); Steven Dickson, Norwalk, CT (US)

Correspondence Address: Law Offices of Lesley L. Coulson, 3413 Holly Road, Annandale, VA, 22003, US

(73) Assignee: SmartEquip, Inc.

(21) Appl. No.: 10/071,346

(22) Filed: Feb. 8, 2002

Related U.S. Application Data
(63) Continuation-in-part of application No. 09/985,902, filed on Nov. 6, 2001.

(51) Int. Cl. G06T 1/00; G06F 17/00; G06T 15/40

(52) U.S. Cl. 345/418; 345/421

(57) ABSTRACT

The present invention provides a method of creating a bounding polygon around a graphical object, wherein the method comprises: creating a rectangular bounding box; placing a plurality of bisectors perpendicular to one side of the rectangular bounding box; for each bisector, determining a set of intersection points between the bisector and the graphical object; and for each set of intersection points, determining edgemost intersection points; wherein the bounding polygon is defined by a set of points created from the edgemost intersection points for each bisector.

The resulting polygon approximates the shape of the graphical object. When this polygon is used as the bounding “box” for a hotspot for a graphical object, there is less negative space within the hotspot, and it becomes possible for a viewing application to select the appropriate graphical object.

### REFERENCE TO RELATED APPLICATIONS

This application is a continuation-in-part of copending U.S. patent application Ser. No. 09/985,902, entitled “Method and System for Building and Using Intelligent Vector Objects”, filed on Nov. 6, 2001, assigned to the assignee of the present Application, SmartEquip, Inc. The entirety of the earlier filed co-pending patent application is hereby expressly incorporated herein by reference.

### FIELD OF THE INVENTION

The present invention relates to the field of computer software. More specifically, the invention relates to a method and system for identifying components in a vector drawing. More particularly, the present invention provides a method for creating a hotspot around an irregularly shaped component using a shape-fitting algorithm.

Portions of the disclosure of this patent document contain material that is subject to copyright protection. The copyright owner has no objection to the facsimile reproduction by anyone of the patent document or the patent disclosure, as it appears in the Patent and Trademark Office file or records, but otherwise reserves all copyrights whatsoever.

### BACKGROUND

### Electronic Illustrated Parts Catalogs

Parts manuals are used in most maintenance, repair and operations (MRO) work within an equipment-related field, as service technicians repair equipment through a hands-on, visual inspection of a specific product, and identify parts in need of replacement by referring to parts manuals. A parts manual, otherwise known as an “Illustrated Parts Catalog” (IPC), typically contains exploded parts diagrams and parts list for each component of a particular model of a product.

Historically, these manuals have been published on paper and distributed to service organizations. With the advent of Computer-Aided Design (CAD) software, drawings created and stored in CAD systems have been used in the printing of published manuals. More recently, many manufacturers and equipment OEMs have implemented electronic IPCs. Electronic IPCs have typically duplicated the paper format IPCs (exploded parts diagram plus parts list, organized by component), and in their simplest incarnation are merely electronic books that add no new functions over paper IPCs.

FIG. 1 illustrates an exploded parts diagram of a pressure washer as used in an electronic IPC. In the example shown in FIG. 1, each part of the pressure washer is identified by a number, as shown by the circled numbers linked by a connecting line to each part. Each circled number indicates an entry in parts legend 120. The view shown in FIG. 1 is an “exploded view” of the pressure washer. An exploded parts diagram visually separates and uniquely identifies each part.

Current electronic IPCs are difficult to use and limited in functionality. The biggest shortcoming of current electronic IPCs is in the way they handle the graphical component of the parts catalog: the exploded parts diagram. Current electronic IPCs typically do not use drawings in their native CAD format. This would require any service organization using the IPC to have software capable of reading and displaying files in their native CAD format. There are many different CAD data formats, and most CAD files require proprietary software to view and manipulate the drawings in the files.

As an alternative to native CAD formats, many current electronic IPCs convert the parts drawings to a raster or bitmap format. Raster or bitmap format files, such as GIF (Graphics Interchange Format) or TIFF (Tag Image File Format), are easily viewable in many applications, including web browsers. However, raster images are large in file size, even when compressed. It is therefore difficult to use raster image files with mobile devices. In addition, because raster images are simply a collection of pixels, raster images suffer from functional constraints. For example, it is very difficult for an application reading a raster image file to distinguish text from line art, and raster images become distorted when zoomed or magnified.

As an alternative to raster, some current electronic IPCs use vector graphic(s) format files, such as CGM (computer graphics metafile) and DXF (Drawing Interchange Format). A vector graphics format allows graphic objects to be represented as geometric shapes (e.g. lines, curves). Graphics described in vector format have a distinct advantage over raster images. The raster formats (GIF, PNG, JPEG and TIFF) are collections of pixels with no connecting information, and result in large files, even with advanced file compression techniques. Raster image formats must transmit all the space around a line as well as the line itself. Vector graphics formats, on the other hand, are mathematically derived representations of points in Cartesian space. Since only the mathematical representations (such as the equation describing a circle) need to be saved or transmitted, the file size or download time of a vector graphic format drawing is greatly reduced. However, the software required to render CGM or DXF files is typically more complex than simple raster image viewing software.

In addition, as with native CAD format files, CGM and DXF are not standard formats that can be universally recognized. Although it is relatively easy to convert drawings from almost any native CAD file format to CGM or DXF, as with native CAD formats, the software capable of viewing even these relatively more standard formats is typically proprietary and not well distributed.

As disclosed in copending U.S. patent application Ser. No. 09/985,902, entitled “Method and System for Building and Using Intelligent Vector Objects”, previously incorporated by reference, the assignee of the present invention has developed a system and method for transforming drawings from native CAD formats, or other formats, to a “smart” format that can be viewed and graphically manipulated by many applications, and that can intelligently link to external information. In this system, a discrete graphical object—a “Real Object Vector Representation” (ROVR)—is created for every element of a product or item represented in a drawing. By creating discrete graphical objects for each element, the system provides for embedding intelligence with each graphical object that is specific to that element. Metadata is attached to the ROVR by which a ROVR can be linked directly to external databases and applications, and provide interactive effects when viewed. For example, for the pressure washer shown in FIG. 1, a ROVR is created for each part, such as part 27, such that when part 27 is selected in a viewing application, detailed part information for part 27 may be shown to the user.

In the disclosed system, parts diagrams, whether paper, raster or native CAD format, are converted to a common vector format, such as Macromedia Flash format. The individual vector graphic elements, e.g. lines, arcs and polygons, which comprise a part are then identified and selected. Typically, a part's identifying number and connecting line are also identified and selected. These are called callouts, or tags. The identified vector graphic elements and part number are stored as a single graphics element entity, or ROVR. Metadata is attached to each ROVR, thereby providing the means for interactivity and linkage to external database records or applications. The ROVR is then stored in a standard scalable vector graphics format file, such as SVG (Standard Vector Graphic) or Macromedia's SWF format.

SVG is an open standard developed under the auspices of the World Wide Web Consortium (W3C). Because it is a standard format, the vast majority of software applications, such as web browsers, can recognize and view SVG files. Unlike CGM or DXF formats, almost all web browsers can view drawings stored in SVG or SWF format files

In one embodiment, each ROVR is displayed as a separate graphical layer in an application that displays all of the layers simultaneously. Within the viewing application, a user can typically select a part, or ROVR, to obtain information or cause an interactive effect, such as highlighting the selected part. There are many different methods that could be used to select a part, or ROVR. For example, a nonvisible, rectangular bounding box could be created for each ROVR. In the simplest case, the rectangular bounding box is the smallest rectangle that encloses all of the graphic elements that comprise a ROVR. This rectangular bounding box acts as a “hotspot”, wherein if the user's cursor or other pointing/selection device is within a particular bounding box, the application knows that the cursor is pointing to the component within that bounding box and can perform whatever actions are appropriate; e.g. highlighting the component, accessing data about the component from an external database, etc.

A bounding box used as a hotspot is typically the smallest rectangle that encompasses all of the vector elements that comprise a part. However, as parts in a parts diagram may be of almost any shape, this rectangular bounding box may contain a great deal of negative space (i.e. space that is not part of the object). This is illustrated in FIG. 2, where the shaded area 205 represents the negative space within bounding box 201 around part 210. If the parts in a parts diagram are closely grouped, the negative space in neighboring bounding boxes may cause the bounding boxes to overlap. In these situations, the viewing application can no longer determine to which part the cursor is pointing as it may simultaneously be within multiple bounding boxes.

An example of this situation is shown in FIG. 12. Even though parts 1201 and 1202 do not overlap, their bounding boxes 1210 and 1220 do. The cross-hatched area 1230 represents the overlapping negative space between bounding box 1210 and bounding box 1220.

It is therefore frequently difficult to select a part when the viewing application uses a standard rectangular bounding box around the graphic elements that make up a part as the hotspot. One solution is to use the part's callout text as the hotspot. However, using the callout text as the hotspot would require every part on a drawing to have a tag. Although it is typical for every part in an exploded parts diagram to have a tag, there may be parts diagrams that do not have tagged parts. In addition, in applications other than electronic IPCs, tags may not be common. It is restraining to require tags for every component. A more intuitive and flexible user interface would allow the user to click on the geometry of a part itself.

To allow the geometry to act as a hotspot, a hotspot polygon could be manually created that follows the shape of a part. However, manually creating such hotspots by tracing the underlying part is a very time-consuming, expensive process. In addition, a hotspot that exactly follows the shape of a complicated part will frequently have many line segments. A complex hotspot polygon may require an inordinate amount of storage space, when a simpler polygon that approximates the shape of the part will work almost as well in ameliorating the problem of overlapping hotspots.

What is needed is a method and system for automatically creating a hotspot for an irregularly shaped component such that unwanted negative space is eliminated or ameliorated.

### SUMMARY OF THE INVENTION

Accordingly, the present invention is directed to a method for creating a shape-fitted bounding polygon around a graphical element.

In accordance with one embodiment of the present invention, there is provided a method of creating a bounding polygon around a graphical object, wherein the method comprises: creating a bounding box; placing a plurality of parallel bisectors; for each bisector, determining a set of intersection points between the bisector and the graphical object; and for each set of intersection points, determining edgemost intersection points; wherein the bounding polygon is defined by a set of points created from the edgemost intersection points for each bisector.

A system for creating a bounding polygon around a graphical object is also provided, wherein the system comprises means for creating a bounding box; means for placing a plurality of parallel bisectors; for each bisector, means for determining a set of intersection points between the bisector and the graphical object; and for each set of intersection points, means for determining edgemost intersection points; wherein the bounding polygon is defined by a set of points created from the edgemost intersection points for each bisector.

The present invention also provides for a computer-readable medium containing instructions for creating a bounding polygon around a vector graphical object, wherein said instructions cause a computer to: create a bounding box; place a plurality of parallel bisectors; for each bisector, determine a set of intersection points between the bisector and the graphical object; and for each set of intersection points, determine edgemost intersection points; wherein the bounding polygon is defined by a set of points created from the edgemost intersection points for each bisector.

A hotspot for a part in a vector-based parts diagram is also provided, wherein the hotspot is created to approximate the shape of the part by: creating a bounding box around the part; placing a plurality of parallel bisectors, such that at least one of the bisectors intersects with the part; determining a set of intersection points for each bisector, wherein the set of intersection points contains all intersection point between the bisector and the part; for each set of intersection points, determining the edgemost points; and defining a bounding polygon from the edgemost points.

In accordance with another embodiment of the present invention, there is provided a method of creating a bounding polygon around a graphical object, wherein said method: determines a centroid for the graphical object; places a bisector through the centroid, wherein the bisector intersects the graphical object at least once; determines all intersection points for the bisector; rotates the bisector; repeatedly determines intersection points and rotates the bisector until the bisector has been rotated 180 degrees; whereby the bounding polygon is defined by a set of points created from the minimal and maximal intersection points for each bisector.

A system for creating a bounding polygon around a graphical object is also provided, wherein said system comprises: means for determining a centroid for the graphical object; means for placing a bisector through the centroid, wherein the bisector intersects the graphical object at least once; means for determining all intersection points for the bisector; means for rotating the bisector; means for determining all intersection points for the rotated bisector and rotating the bisector again until the bisector has been rotated 180 degrees; whereby the bounding polygon is defined by a set of points created from the minimal and maximal intersection points for each bisector.

The present invention also provides for a computer-readable medium containing instructions for creating a bounding polygon around a vector graphical object, wherein said instructions cause a computer to: determine a centroid for the graphical object; place a bisector through the centroid, wherein the bisector intersects the graphical object at least once; determine all intersection points for the bisector; rotate the bisector; repeat the determining of intersection points for the rotated bisector and rotating the bisector repeatedly until the bisector has been rotated 180 degrees; whereby the bounding polygon is defined by a set of points created from the minimal and maximal intersection points for each bisector.

A further aspect of the invention provides for a hotspot for a part in a vector-based parts diagram, wherein the hotspot is created to approximate the shape of the part by: determining the centroid of the part; placing a bisector such that it intersects with the centroid; determining a set of intersection points for the bisector, rotating the bisector and determining a set of intersection points for the rotated bisector repeatedly, until the bisector has been rotated 180 degrees; for each set of intersection points, determining the maximal and minimal points; and defining a bounding polygon from these points; wherein said bounding polygon is used as the hotspot for the part.

The present invention also provides for a system for automatically creating a bounding polygon for a graphic element, wherein the system comprises: means for calculating a bounding polygon for the graphic element using parallel bisectors; means for calculating a bounding polygon for the graphic element using radial bisectors; means for selecting the best means for calculating the bounding polygon based on a characteristic of the graphic element.

Additional features and advantages of the invention will be set forth in the description that follows, and in part will be apparent from the description, or may be learned by practice of the invention. The objectives and advantages of the invention will be realized and attained by the system particularly pointed out in the written description and claims hereof as well as the appended drawings.

### DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention,

In the drawings:

FIG. 1 shows an exploded parts diagram used in an IPC for a pressure washer.

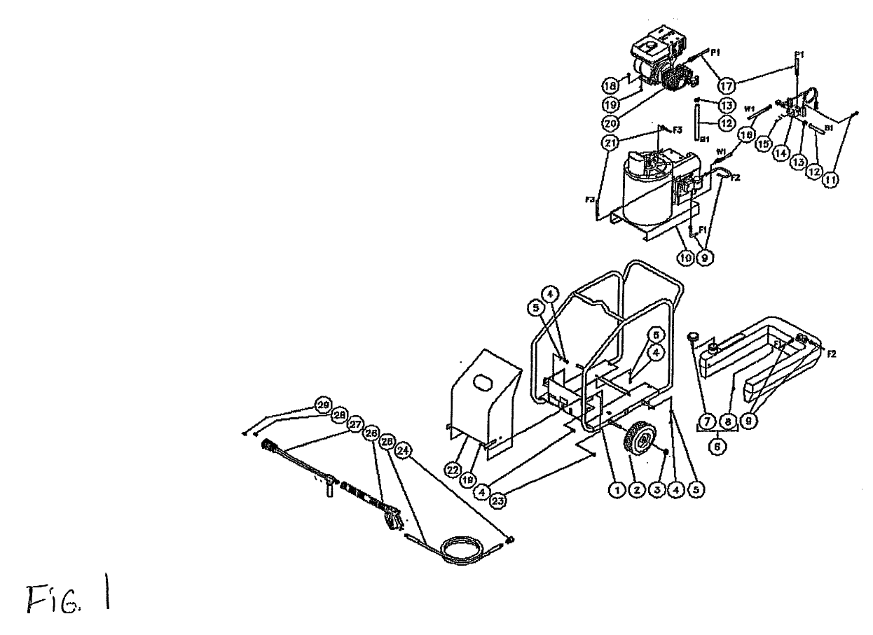

FIG. 2 illustrates the negative space around a part when a rectangular bounding box is used.

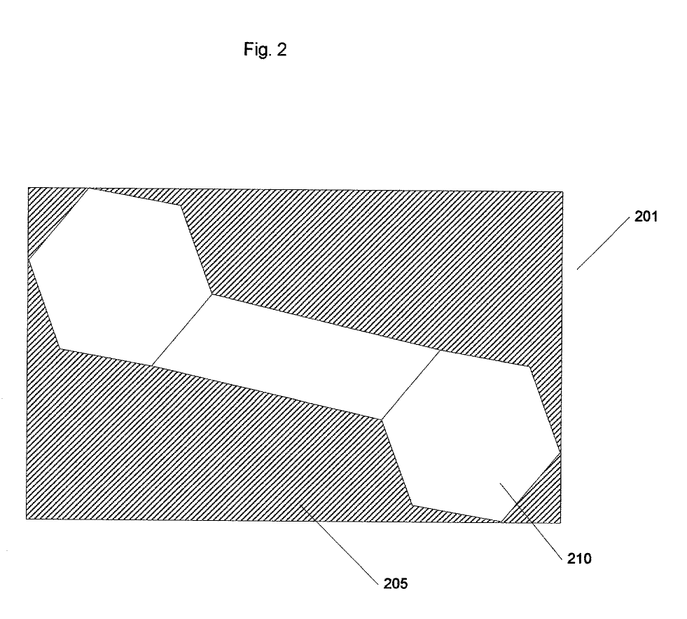

FIG. 3 shows a high level flowchart illustrating the steps involved in shrink-fitting a bounding polygon using parallel bisectors.

FIG. 4 illustrates a rectangular bounding box around an irregularly shaped part S.

FIG. 5 illustrates the bounding box of FIG. 4 with six bisectors placed vertically.

FIG. 6 illustrates the set of intersections [I] with S for each bisector of FIG. 5.

FIG. 7 illustrates bounding polygon P that follows the shape of the part in the drawing in FIG. 4 created using the edgemost intersections of the set of intersection I.

FIG. 8 illustrates bisectors placed through the centroid of the irregularly shaped part of FIG. 4.

FIG. 9 illustrates the set of intersections [I] with the part for each bisector of FIG. 8, and the resulting bounding polygon P.

FIG. 10 compares the bounding polygon of FIG. 7 and the bounding polygon of FIG. 9.

FIG. 11 shows a high level flowchart illustrating the steps involved in the inventive method using radial bisectors.

FIG. 12 illustrates overlapping bounding boxes.

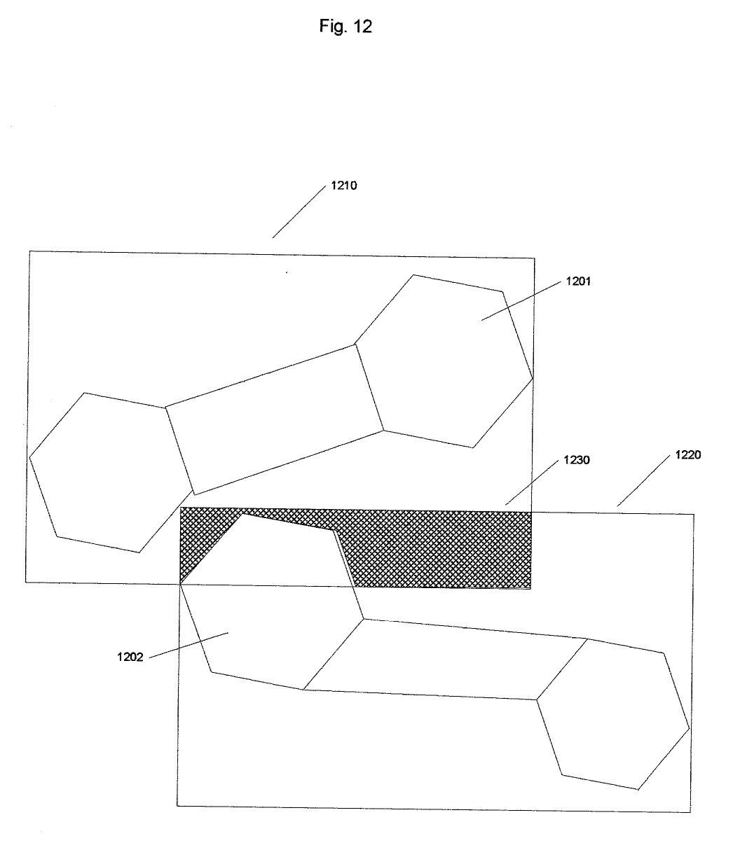

### DETAILED DESCRIPTION

In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

The present invention provides a method and system for ameliorating the problem of excess negative space in a rectangular bounding box by fitting the bounding ‘box’ to the actual shape of the underlying component or graphical object. That is, a rectangular bounding box becomes a bounding polygon that closely follows the actual shape of the component. When the bounding polygon is used as a hotspot for the component, and the cursor or other selection device is within the shape-fitted hotspot, the viewing application knows precisely which component should be selected.

Although the present invention is described using the example of a parts diagram used in an electronic IPC, it will be obvious to those skilled in the art that the present invention can be used in a variety of applications. It is not required that the underlying component be a part in a parts diagram, it can be any type of graphical object. The IPC is used merely as an example, and other uses for the invention method will be obvious to those skilled in the art, and are intended to come within the scope of the present invention.

The present invention creates a shape-fitting bounding polygon for a discrete graphical object. In the example used herein, a discrete graphical object corresponds to a part in a parts diagram. That is, in the example of an exploded parts diagram for a manufactured item, a discrete graphical object is created for every numbered element in the exploded parts diagram, and the method of present invention provides the means to automatically create a shape-fitted bounding polygon for each numbered part.

### Shrink-Fitting Process Using Parallel Bisectors

In one embodiment, the inventive method transforms a rectangular bounding box into a shape-fitted bounding polygon through a process that is analogous to shrink-wrapping. In this analogy, each side of the starting bounding box is broken into a number of smaller line segments. Each segment is pushed inward toward the center of the box until it touches the outer boundary of the component. By repeating this process for every segment on every side, the segments are “draped” over the component. The resulting line segments form the shape-fitted bounding polygon around the component. The higher the number of line segments used, the more closely the bounding polygon fits the shape of the component. In fact, a rectangular bounding box can be viewed as the simplest case in which only one line segment per side is used to fit the component.

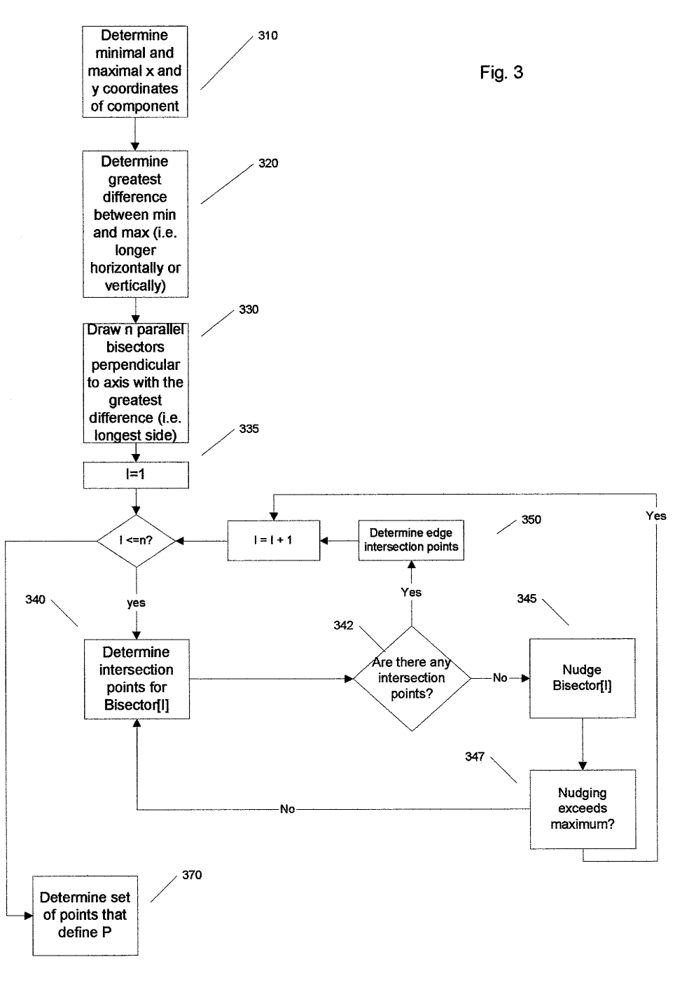

One embodiment of the inventive shrink-fitting process for creating a shape-fitted bounding polygon is shown in FIG. 3.

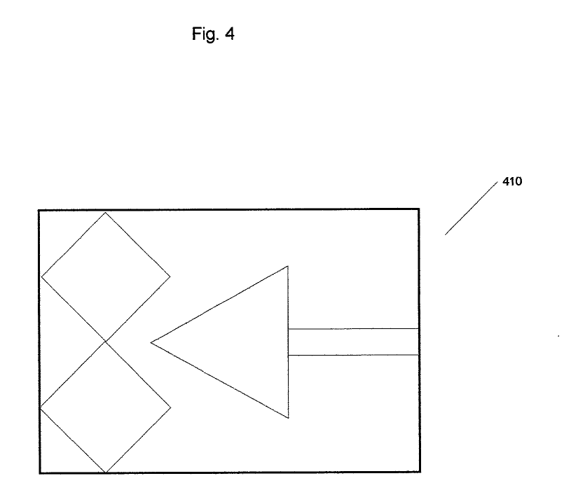

For the purposes of the following discussion, the component is comprised of a non-empty set S of line segments [1 . . . m], where the line segments are the individual graphic elements that comprise the component. For example, for the part shown in FIG. 4, there are 15 line segments.

As shown in step 310, the first step in this embodiment of the process is to determine the minimal and maximal limits of the underlying component along the x and y axes. One method for determining the minimal and maximal limits is to create the smallest rectangular bounding box that fully encloses S. The smallest rectangular bounding box for the part in FIG. 4 is shown as box 410. The limits in this case are defined by the rectangular bounding box. That is, the minimal and maximal y coordinates are defined by the top and bottom of the rectangular bounding box, while the minimal and maximal x coordinates are defined by the left and right sides of the rectangular bounding box. Other methods of determining the minimal and maximal limits of the underlying component will be obvious to those skilled in the art, and are intended to come within the scope of the present invention.

The next step, as shown by step 320 in FIG. 3, is to determine the greatest difference between the minimal and maximal limits along each axis. On other words, whether the underlying component is longer in the horizontal or vertical plane. For example, if a rectangular bounding box is used to determine the limits, the greatest difference between the minimal and maximal limits is the longest side. While the invention is described such that the component and the bounding box is in the horizontal and vertical planes, it should be obvious to one skilled in the art that an object may be oriented at any angle. Although the description herein assumes a horizontal/vertical orientation, it should be obvious to one skilled in the art that the present invention is easily extensible to the more generic arbitrary orientation case.

At step 330, n evenly-spaced imaginary lines are placed perpendicular to the axis that has the greatest difference between the minimal and maximal limits. For example, if a rectangular bounding box is used, the lines are placed parallel to one another and perpendicular to the longer side, such that the lines span the bounding box from one side to the other. It should be obvious to one skilled in the art that bisectors may instead be placed along the shorter side, however the resulting shrink-wrapped polygon conforms more closely to the actual shape of the component if the longer side is used. It is intended that either method come within the scope of the present invention. If the sides are of equal distance, i.e. the bounding box is square, either side may be used.

The number of bisectors used in the shrink-wrapping process may be a fixed number. Alternatively, the number of bisectors may be automatically calculated based on some geometric property of set S. For example, the number of bisectors may linearly increase with the width, height or area of the original bounding box around S, or with the width, height or area of S itself.

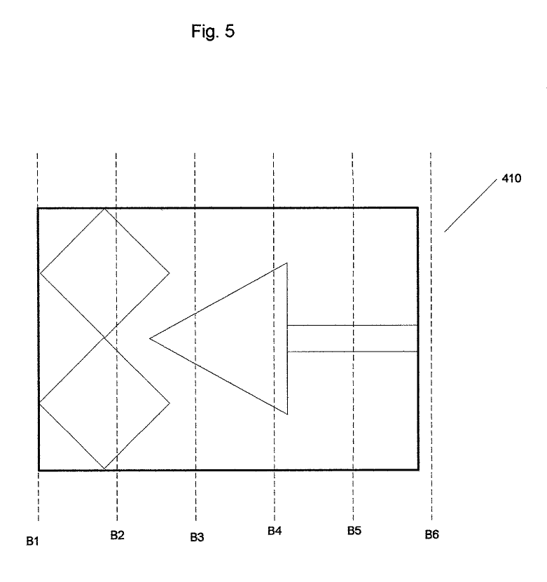

These imaginary lines are called “bisectors” as they bisect the component and the bounding box, if a bounding box is used. FIG. 5 shows the case where n is 6 and the horizontal side is the longer side of the bounding box. As shown, 6 vertical bisectors are placed along the x-axis. As discussed above, using a greater number of bisectors, i.e. increasing n, results in a more precise shape-fitted polygon. The set of bisectors is called B[1 . . . n]. Bisectors B1, B2, B3, B4, B5 and B6 are labeled in FIG. 5.

The points of intersection with S for each bisector are determined, then for each bisector, the edgemost intersection points are determined. In the rectangular bounding box example, the points that are closest to the rectangular bounding box are the edgemost points. This is shown by loop 335-340-350 in the implementation shown in FIG. 3. At step 335, a counter is initiated. At step 340, the intersection points between the current bisector and the underlying component are determined for that bisector. There are many different methods known to those skilled in the art to determine the intersection points. One of the most common methods is to use the parametric equations. As is known to those skilled in the art, the parametric equation for a line is in the form y=mx+b, where m is the slope of the line and b is the y-intercept of the line, and x and y are the coordinate values in Cartesian space. The intersection between two lines L1 and L2 in parametric forms y=m1x+b1 and y=m2x+b2 respectively, may be calculated by:

X(intersection)=(b1−b2)/(m2−m1)

Y(intersection)=b1+(m1*x(intersection))

However, it is the intersection between a line segment and a bisector line that is to be calculated here. This may be accomplished in a similar manner. X(intersection) and Y(intersection) between a bisector line and a line segment of the underlying component are calculated as shown above, then a check is performed to ensure that this intersection point lies on the line segment in question. If it does not, then the bisector does not intersect the line segment. One method is to check to see if the intersection point X(intersection), Y(intersection) lies between the two endpoints of the line segment. If X1, Y1 is one endpoint of the line segment, and X2, Y2 is the other endpoint, then in order for X(intersection), Y(intersection) to lie on the line segment, then the following conditions must be met:

X1>=X(intersection)>=X2

Y1>=Y(intersection)>=Y2

where x1<x2 and y1<y2.

Other methods of determining intersection points are known to those skilled in the art, and are intended to come within the scope of the present invention.

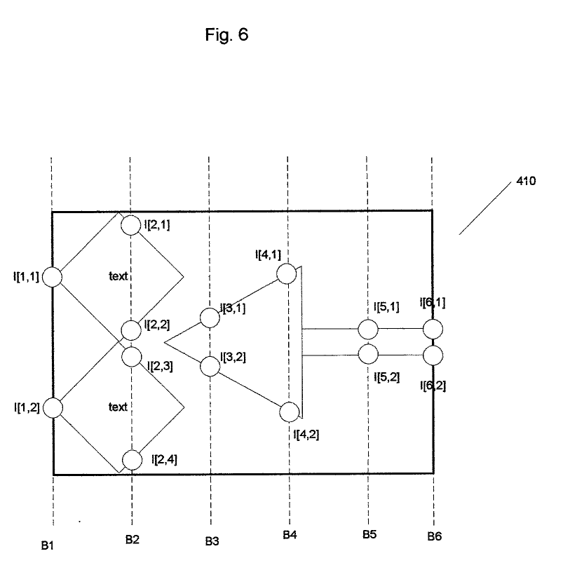

FIG. 6 illustrates the results of calculating all points of intersection between bisectors B1-B6 and the underlying component for the example shown in FIG. 4. In an alternative embodiment, steps 340 and 350 are combined. That is, the edgemost points are determined as the intersection points are determined.

In the example shown in FIG. 6, every bisector intersects the underlying component at least once. However, there may be situations where there are gaps between lines and/or the underlying component contains spatially separated subcomponents. Gaps may occur for a number of reasons. For example, there may be imprecision in the original drawing or ambiguity may be introduced in subsequent processing. Artistic effects to make the drawing easier to view or interpret may have been introduced. The drawing may also make use of dashed lines. In these cases, a bisector may not intersect with any underlying line segments. At step 342 in these cases, the process will continue to step 345 before continuing to step 350.

At step 345, the bisector is “nudged” until it intersects with an underlying line segment. Nudging deals with small gaps between lines in the drawing, and it provides a means for identifying gaps between spatially separated subcomponents.

In the nudging process, the x-value of a vertical bisector is increased (or decreased), or the y-value of a horizontal bisector is increased (or decreased) by a small amount. The amount is arbitrary, and may be a fixed value, or it may be scaled according to the size or geometry of the underlying component, or it may vary depending on the number of bisectors or other factors. If the nudged bisector still does not intersect with at least one underlying line segment, it is nudged again in the same direction, preferably by the same amount. The nudging process continues until the bisector intersects with at least one underlying line segment. A maximum number of nudges may also be set to guard against infinite nudging, as shown by step 347. This maximum may be a fixed number, or it may be determined by the geometry of the underlying component, the number of bisectors, or other factors. If the bisector still does not intersect with an underlying line segment after it has been nudged a maximum number of times, this signifies that the bisector falls between two spatially separated subcomponents, and no edgemost intersections are determined for this bisector in step 350.

If the bisector intersects with at least one underlying line segment, the edgemost intersections are determined at step 350. For a horizontal bisector, the edgemost intersections are the leftmost intersection along B[a] and the rightmost intersections along B[a]. For a vertical bisector, the edgemost intersections are the topmost intersection along B[a] and the bottommost intersection along B[a].

The intersections for the bisectors of FIG. 5 are shown in FIG. 6. As shown, bisector 1 has 2 intersections—I[1,1] and I[2,1]. Bisector 2 has 4 intersections—I[2,1], I[2,2], I[2,3] and I[2,4], and so forth. The edgemost intersections for Bisector 1 are I[1,2] as the bottommost, and I[1,1] as the topmost. The edgemost intersections for Bisector 2 are [2,4] as the bottommost and [2,1] as the topmost. Similar determinations are made for the remaining bisectors.

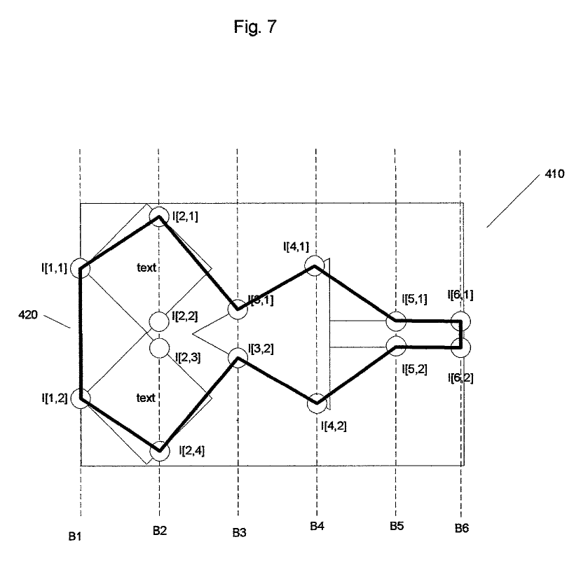

The shape-fitted bounding polygon is created by connecting the edgemost intersections of each bisector at step 370. FIG. 7 illustrates shape-fitted polygon 420 that was created by connecting the bottommost, then the topmost intersections determined in step 350. One method of creating the bounding polygon is to create the ordered set of Points P[1 . . . (n*2)] such that, for each bisector B[a], P[a]=I[a][i] and P[(n*2)−a+1]=I[a][j], where I[a][i] is the intersection point with the smallest x-value (leftmost) for horizontal bisectors, and smallest y-value (bottommost) for vertical bisectors, and I[a][j] is the intersection point with the largest x-value (rightmost) for horizontal bisectors, and the largest y-value (topmost) for vertical bisectors.

The resulting shape-fitted polygon closely follows the shape of the underlying component, however, it may contain a small amount of negative space, and/or may exclude small parts of the component, as shown in FIG. 7. To increase the accuracy of the shape-fitted polygon, the number of bisectors N may be increased. However, an increase in N increases the number of segments in the shape-fitted polygon, and the therefore the resultant file. It is a tradeoff between precision and complexity. In the above-described example, the goal is to create a hotspot, and since the hotspot is only part of the GUI, a small loss in precision is a small price to pay for the large benefit of a greatly reduced file size. A large number of bisectors are generally not needed when creating a hotspot, as the hotspot does not have to be very precise. It is a feature of the present invention that the resultant shape-fitted polygon is typically comprised of fewer segments than the original component, and therefore requires less storage space. When using the present invention in other applications, using a larger (or smaller) number of bisectors may be appropriate.

Although the invention has been described using the example of turning a rectangular bounding box into a shape approximating polygon, it will be obvious to those skilled in the art that a rectangular bounding box is not required. For example, the starting bounding “box” could be a circle, wherein the inventive method would place bisectors perpendicular to the x or y axis such that the bisectors intersect the underlying component. Other types of geometric bounding “boxes” could also used, and it is intended the scope of the present invention include such cases. The term “box” should not be limited to rectangular shapes. It is also possible to use no starting bounding box at all, and simply draw bisectors perpendicular to an axis that intersect the underlying component.

In addition, in the example above, the parallel bisectors are evenly spaced. As will be obvious to one skilled in the art, the bisectors need not be evenly spaced, but may be placed at random intervals, or the placement of the bisectors may be determined from the underlying geometry of the component

### Shrink-Fitting Process Using Radial Bisectors

While in the above example, a set of parallel bisectors are placed along an axis of the component, in an alternative embodiment a set of radial bisectors are placed through the centroid of the underlying component at varying angles. In this embodiment, the intersections with the maximal and minimal x-value (or y-value) form the shape-fitted bounding polygon.

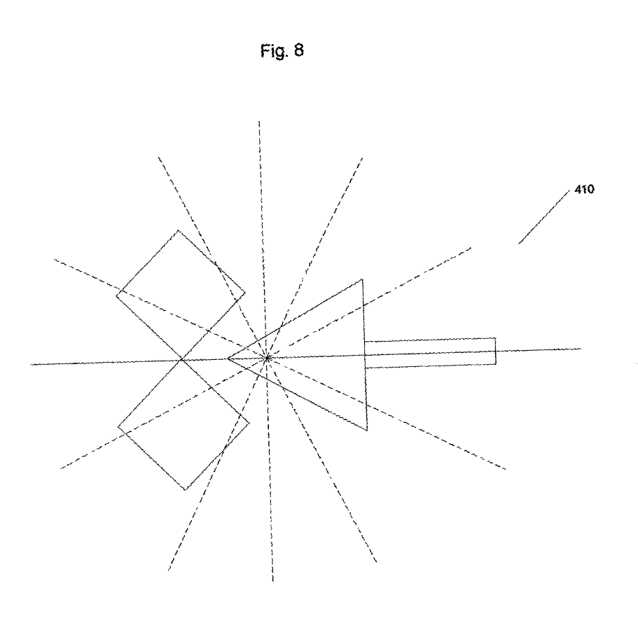

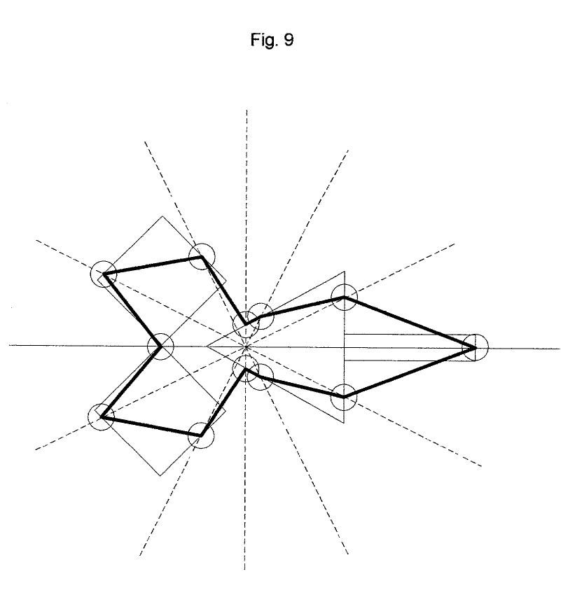

FIG. 8 illustrates the component of FIG. 4 with a set of bisectors spaced 30 degrees apart. FIG. 9 illustrates the bounding polygon that results from connecting the minimal and maximal intersection points for each bisector.

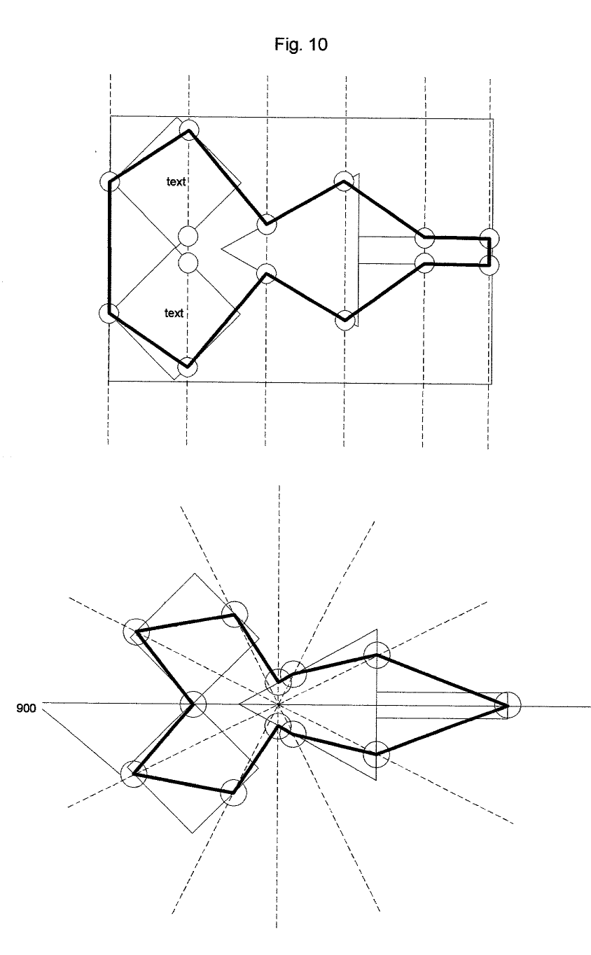

FIG. 10 illustrates the shape-fitted bounding polygons from FIGS. 7 and 9 that were created using the parallel bisector embodiment and radial bisectors embodiment respectively. As shown in the area marked as 900 in FIG. 10, the radial bisector embodiment may deal with concavities in the underlying component better than the parallel bisector embodiment. However, the radial bisector embodiment requires more complex calculations and is generally more computationally expensive. It is not required that the same shape-fiting process be performed on every part. An application that automatically calculates bounding polygons for parts in a parts drawing may select the most appropriate process depending on the shape of the underlying part, for example.

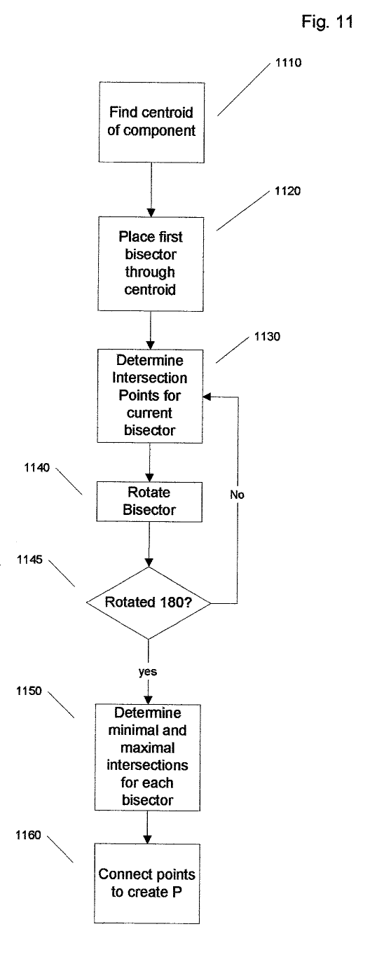

The basic algorithm for the radial bisector embodiment of the present invention is shown in FIG. 11. As shown, the centroid of the component is first determined at step 1110. There are many different ways of determining the centroid of a graphical object, as will be obvious to those skilled in the art. In addition, it is not required that the exact centroid be determined—an approximation is sufficient. A first bisector is placed that goes through the centroid. This bisector may be horizontal, for example. The intersection points with the underlying component for this bisector are calculated at step 1130, then the bisector is rotated by a certain amount at step 1140. In the example shown in FIG. 8, the bisectors are rotated 30 degrees at a time. The amount to rotate the bisector may be a fixed amount, or it may be a variable amount determined by the geometry of the underlying component, for example. The intersection points are calculated for each bisector until the bisector has been rotated 180 degrees at step 1145. The minimal and maximal intersections are determined for each bisector, and the shape-fitted polygon is created from the set of minimal and maximal intersections at step 1160.

As with the parallel bisectors, the accuracy of the radial bisector shape-fitting algorithm increases with the number of bisectors used. In addition, as the size of the underlying component increases, the shape-fitting of both the parallel bisector embodiment and the radial bisector embodiment become less accurate. This is because as the size of the object increases, so does the size of the arc between the radial bisectors, and the space between parallel bisectors. Increasing the number of bisectors ameliorates this problem. In either embodiment, the optimal number of bisectors to use may be determined based on some attribute of the underlying component, such as area, geometry and so forth.

The foregoing description has been directed to specific embodiments of this invention. It will be apparent, however, that other variations and modifications may be made to the described embodiments, with the attainment of some or all of their advantages. For example, it may be possible to place random scattered bisectors, ie. not parallel, across the component.

Therefore, it is the object of the appended claims to cover all such variations and modifications as come within the true spirit and scope of the present invention.

What is claimed:

1. In a computer system, a method of creating a bounding polygon around a graphical object, comprising the steps of:
(a) creating a starting bounding box;
(b) placing a plurality of bisectors perpendicular to one side of the bounding box;
(c) for each bisector, determining a set of intersection points between the bisector and the graphical object; and
(d) for each set of intersection points, determining edgemost intersection points; wherein
the bounding polygon is defined by a set of points created from the edgemost intersection points for each bisector.

2. The method of claim 1, wherein the starting bounding box is created by creating a rectangle that encompasses the vectors that comprise the graphical object.

3. The method of claim 2, wherein the rectangular bounding box is the smallest rectangle that encompasses every vector of the graphical object.

4. The method of claim 2, wherein step (b) additionally comprises determining the longest side of the rectangular bounding box and placing the plurality of bisectors perpendicular to the longest side.

5. The method of claim 1, wherein the graphical object is a part in a parts diagram.

6. The method of claim 1, wherein the number of bisectors is a fixed number.

7. The method of claim 1, wherein the number of bisectors is automatically calculated.

8. The method of claim 7, wherein the number of bisectors is automatically calculated from the size of the graphical object.

9. The method of claim 7, wherein the number of bisectors is automatically calculated from the geometry or shape of the graphical object.

10. The method of claim 1, wherein step (c) comprises finding intersection points between the bisector and the line segments of the graphical object using parametric equations.

11. The method of claim 1, wherein if a set of intersection points for a bisector is empty, the bisector is moved a small amount and a new set of intersection points for that bisector is determined.

12. The method of claim 11, wherein the small amount to move the bisector is fixed.

13. The method of claim 11, wherein the small amount to move the bisector is automatically calculated.

14. The method of claim 13, wherein the automatically calculated small amount to the move the bisector is based on the total number of bisectors.

15. The method of claim 11, wherein if the new set of intersection points is empty, the bisector is further moved.

16. The method of claim 11, wherein the bisector is moved by a small amount repetitively until a maximum number of movements is reached or until the set of intersection points for that bisector is not empty.

17. The method of claim 16, wherein if the maximum number of movements is reached, the empty set of points for the bisector is not used in determining the bounding polygon.

18. The method of claim 1, wherein the edgemost intersection points for a bisector are the highest and lowest points if the bisector is vertical, and leftmost and rightmost points if the bisector is horizontal.

19. The method of claim 1, wherein the edgemost points for a bisector are the same point, such that this same point is used twice in defining the bounding polygon.

20. The method of claim 1, wherein said bounding polygon is used as a hotspot for the graphical object in an application.

21. The method of claim 1, wherein said starting bounding box is a circle that encloses the vectors of the graphical element and the bisectors are placed perpendicular to an axis.

22. A system for creating a bounding polygon around a graphical object, comprising:
(a) means for creating a starting bounding box;
means for placing a plurality of parallel bisectors;
for each bisector, means for determining a set of intersection points between the bisector and the graphical object; and
for each set of intersection points, means for determining edgemost intersection points;
wherein the bounding polygon is defined by a set of points created from the edgemost intersection points for each bisector.

23. The system of claim 22, wherein the means for creating the starting bounding box creates a rectangle that encompasses vectors that comprise of the graphical object.

24. The system of claim 23, wherein the bounding box is the smallest rectangle that encompasses every vector element of the graphical object.

25. The system of claim 23, wherein the means for placing a plurality of bisectors additionally comprises means for determining the longest side of the rectangular bounding box and placing the plurality of bisectors perpendicular to the longest side.

26. The system of claim 22, wherein the graphical object is a part in a parts diagram.

27. The system of claim 22, wherein the number of bisectors is a fixed number.

28. The system of claim 22, additionally comprising means for automatically calculating the number of bisectors to use.

29. The system of claim 28, wherein the number of bisectors is automatically calculated from the size of the graphical object.

30. The system of claim 28, wherein the number of bisectors is automatically calculated from the geometry or shape of the graphical object.

31. The system of claim 22, wherein the means for determining a set of intersection points comprises means for finding intersection points between the bisector and the line segments of the graphical object using parametric equations.

32. The system of claim 22, additionally comprising means for moving the bisector a small amount and determining a new set of intersection points if a set of intersection points for a bisector is empty.

33. The system of claim 32, wherein the small amount to move the bisector is fixed.

34. The system of claim 32, additionally comprising means for automatically calculating the small amount to move the bisector.

35. The system of claim 34, wherein the means for automatically calculating the small amount to move uses the total number of bisectors in the calculation.

36. The system of claim 32, additionally comprising means for further moving the bisector if the new set of intersection points is empty.

37. The system of claim 32, additionally comprising means for moving the bisector by a small amount repetitively until a maximum number of movements is reached or until the set of intersection points is not empty.

38. The system of claim 37, wherein if the maximum number of movements is reached, the empty set of points for the bisector is not used in determining the bounding polygon.

39. The system of claim 22, wherein the edgemost intersection points for a bisector are the highest and lowest points if the bisector is vertical, and leftmost and rightmost points if the bisector is horizontal.

40. The system of claim 22, wherein the edgemost points for a bisector are the same point, such that this same point is used twice in defining the bounding polygon.

41. The system of claim 22, wherein said bounding polygon is used as a hotspot for the graphical object in an application.

42. A computer-readable medium containing instructions for creating a bounding polygon around a vector graphical object, wherein said instructions cause a computer to:
create a starting bounding box;
place a plurality of parallel bisectors;
for each bisector, determine a set of intersection points between the bisector and the graphical object; and
for each set of intersection points, determine edgemost intersection points; wherein
the bounding polygon is defined by a set of points created from the edgemost intersection points for each bisector.

43. The computer-readable medium of claim 42, wherein said instruction creates the starting bounding box by creating a rectangle that encompasses the vectors that comprise the graphical object.

44. The computer-readable medium of claim 43, wherein the bounding box is the smallest rectangle that encompasses every vector element of the graphical object.

45. The computer-readable medium of claim 43, wherein said instructions for placing a plurality of bisectors comprises instructions for determining the longest side of the rectangular bounding box and placing the plurality of bisectors perpendicular to the longest side.

46. The computer-readable medium of claim 42, wherein the graphical object is a part in a parts diagram.

47. The computer-readable medium of claim 42, wherein the number of bisectors is a fixed number.

48. The computer-readable medium of claim 42, additionally comprising instructions for automatically calculating the number of bisectors.

49. The computer-readable medium of claim 48, wherein the instructions for automatically calculating the number of bisectors use the size of the component in the calculation.

50. The computer-readable medium of claim 48, wherein the instructions for creating a set of intersection points automatically calculates the number of bisectors to use from the geometry or shape of the graphical object.

51. The computer-readable medium of claim 42, wherein the instructions for creating a set of intersection points finds intersection points between the bisector and the line segments of the graphical object using parametric equations.

52. The computer-readable medium of claim 42, wherein if a set of intersection points for a bisector is empty, the instructions additionally comprise instructions for moving the bisector a small amount and determining a new set of intersection points for that bisector.

53. The computer-readable medium of claim 52, wherein the small amount to move the bisector is fixed.

54. The computer-readable medium of claim 52, wherein the instructions automatically calculate the small amount to move the bisector.

55. The computer-readable medium of claim 54, wherein the instructions automatically calculate the small amount to the move the bisector based on the total number of bisectors.

56. The computer-readable medium of claim 52, wherein the instructions move the bisector further if the new set of intersection points is empty.

57. The computer-readable medium of claim 52, wherein the instructions cause the bisector to be moved by a small amount repetitively until a maximum number of movements is reached or until the set of intersection points is not empty.

58. The computer-readable medium of claim 57, wherein if the maximum number of movements is reached, the empty set of points for the bisector is not used in determining the bounding polygon.

59. The computer-readable medium of claim 52, wherein the edgemost intersection points for a bisector are the highest and lowest points if the bisector is vertical, and leftmost and rightmost points if the bisector is horizontal.

60. The computer-readable medium of claim 52, wherein the edgemost points for a bisector are the same point, such that this same point is used twice in defining the bounding polygon.

61. The computer-readable medium of claim 52, wherein the bounding polygon is used as a hotspot for the component in an application.

62. The computer-readable medium of claim 52, wherein the starting bounding box is a circle enclosing the vectors that comprise the graphical object and the bisectors are placed perpendicular to an axis.

63. A hotspot for a part in a vector-based parts diagram, wherein the hotspot is created to approximate the shape of the part by:
creating a bounding box around the part;
placing a plurality of bisectors such that at least one of the bisectors intersects with the part;
determining a set of intersection points for each bisector, wherein the set of intersection points contains all intersection point between the bisector and the part;
for each set of intersection points, determining the edgemost points; and
defining a bounding polygon from the edgemost points;
wherein said bounding polygon is used as the hotspot for the part.

64. In a computer system, a method of creating a bounding polygon around a graphical object, comprising the steps of:
(a) determining a centroid for the graphical object;
(b) placing a bisector through the centroid, wherein the bisector intersects the graphical object at least once;
(c) determining all intersection points for the bisector;
(d) rotating the bisector;
(e) repeating steps (c) and (d) until the bisector has been rotated 180 degrees; whereby
the bounding polygon is defined by a set of points created from the minimal and maximal intersection points for each bisector.

65. The method of claim 64, wherein the graphical object is a part in a parts diagram.

66. The method of claim 64, wherein the angle that the bisector is rotated is a fixed angle.

67. The method of claim 64, wherein the angle to rotate the bisector in step (d) is automatically calculated.

68. The method of claim 67, wherein the angle is automatically calculated from the size of the graphical object.

69. The method of claim 67, wherein the angle is automatically calculated from the geometry or shape of the graphical object.

70. The method of claim 64, wherein step (c) comprises finding intersection points between the bisector and the line segments of the graphical object using parabolic equations.

71. The method of claim 64, wherein said bounding polygon is used as a hotspot for the graphical object in an application.

72. The method of claim 64, wherein said centroid is an approximation of the true centroid.

73. A system for creating a bounding polygon around a graphical object, comprising:
means for determining a centroid for the graphical object;
means for placing a bisector through the centroid, wherein the bisector intersects the graphical object at least once;
means for determining all intersection points for the bisector;
means for rotating the bisector;
means for determining all intersection points for the rotated bisector and rotating the bisector again until the bisector has been rotated 180 degrees; whereby
the bounding polygon is defined by a set of points created from the minimal and maximal intersection points for each bisector.

74. The system of claim 73, wherein the graphical object is a part in a parts diagram.

75. The system of claim 73, wherein the angle that the bisector is rotated is a fixed angle.

76. The system of claim 73, wherein the angle to rotate the bisector is automatically calculated.

77. The system of claim 75, wherein the angle is automatically calculated from the size of the graphical object.

78. The system of claim 75, wherein the angle is automatically calculated from the geometry or shape of the graphical object.

79. The system of claim 73, wherein said means for determining intersection points comprises means for finding intersection points between the bisector and the line segments of the graphical object using parabolic equations.

80. The system of claim 73, wherein said bounding polygon is used as a hotspot for the graphical object in an application.

81. The system of claim 73, wherein said means for determining the centroid comprises means for determining an approximate centroid of the graphical object.

82. A computer-readable medium containing instructions for creating a bounding polygon around a vector graphical object, wherein said instructions cause a computer to:
determine a centroid for the graphical object;
place a bisector through the centroid, wherein the bisector intersects the graphical object at least once;
determine all intersection points for the bisector;
rotate the bisector;
repeat the determining of intersection points for the rotated bisector and rotating the bisector repeatedly until the bisector has been rotated 180 degrees;
whereby the bounding polygon is defined by a set of points created from the minimal and maximal intersection points for each bisector.

83. The computer-readable medium of claim 82, wherein the graphical object is a part in a parts diagram.

84. The computer-readable medium of claim 82, wherein the angle that the bisector is rotated is a fixed angle.

85. The computer-readable medium of claim 82, additionally comprising instructions to automatically calculate the angle to rotate the bisector.

86. The computer-readable medium of claim 85, wherein the angle is automatically calculated from the size of the graphical object.

87. The computer-readable medium of claim 85, wherein the angle is automatically calculated from the geometry or shape of the graphical object.

88. The computer-readable medium of claim 82, additionally comprising instructions to find intersection points between a bisector and the line segments of the graphical object using parabolic equations.

89. The computer-readable medium of claim 82, wherein said bounding polygon is used as a hotspot for the graphical object in an application.

90. The computer-readable medium of claim 82, wherein said instructions to determine the centroid determines an approximate centroid.

91. A hotspot for a part in a vector-based parts diagram, wherein the hotspot is created to approximate the shape of the part by:
determining a centroid of the part;
placing a bisector such that it intersects with the centroid;
determining a set of intersection points for the bisector,
rotating the bisector and determining a set of intersection points for the rotated bisector repeatedly, until the bisector has been rotated 180 degrees;
for each set of intersection points, determining the maximal and minimal points; and defining a bounding polygon from these points;
wherein said bounding polygon is used as the hotspot for the part.

92. A system for automatically creating a bounding polygon for a graphic element, wherein the system comprises:
means for calculating a bounding polygon for the graphic element using parallel bisectors;
means for calculating a bounding polygon for the graphic element using radial bisectors; and
means for selecting the best means for calculating the bounding polygon based on a characteristic of the graphic element.

93. The system of claim 92, additionally comprising means for calculating a bounding polygon using randomly placed bisectors.

94. In a computer system, a method of creating a bounding polygon around a graphical object, comprising the steps of:
(a) determining minimal and maximal limits of the graphical object;
(b) placing a plurality of parallel bisectors through the graphical object perpendicular to an axis;
(c) for each bisector, determining a set of intersection points between the bisector and the graphical object; and
(d) for each set of intersection points, determining edgemost intersection points; wherein
the bounding polygon is defined by a set of points created from the edgemost intersection points for each bisector.

95. The method of claim 94, wherein the minimal and maximal limits are determined by creating the smallest rectangular bounding box that encompasses all of the vectors that comprise the graphical object.

96. The method of claim 95, wherein step (b) additionally comprises determining the longest side of the rectangular bounding box and placing the plurality of bisectors perpendicular to the longest side.

97. The method of claim 94, wherein the graphical object is a part in a parts diagram.

98. The method of claim 94, wherein the number of bisectors is a fixed number.

99. The method of claim 94, wherein the number of bisectors is automatically calculated.

100. The method of claim 99, wherein the number of bisectors is automatically calculated from the size of the graphical object.

101. The method of claim 99, wherein the number of bisectors is automatically calculated from the geometry or shape of the graphical object.

102. The method of claim 94, wherein step (c) comprises finding intersection points between the bisector and the line segments of the graphical object using parametric equations.

103. The method of claim 94, wherein if a set of intersection points for a bisector is empty, the bisector is moved a small amount and a new set of intersection points for that bisector is determined.

104. The method of claim 103, wherein the small amount to move the bisector is fixed.

105. The method of claim 103, wherein the small amount to move the bisector is automatically calculated.

106. The method of claim 105, wherein the automatically calculated small amount to the move the bisector is based on the total number of bisectors.

107. The method of claim 103, wherein if the new set of intersection points is empty, the bisector is further moved.

108. The method of claim 103, wherein the bisector is moved by a small amount repetitively until a maximum number of movements is reached or until the set of intersection points for that bisector is not empty.

109. The method of claim 108, wherein if the maximum number of movements is reached, the empty set of points for the bisector is not used in determining the bounding polygon.

110. The method of claim 94, wherein the edgemost intersection points for a bisector are the highest and lowest points if the bisector is vertical, and leftmost and rightmost points if the bisector is horizontal.

111. The method of claim 94, wherein said bounding polygon is used as a hotspot for the graphical object in an application.
